(19) United States
(12) Patent Application Publication
(10) Pub. No.: US 2018/0005276 A1
(43) Pub. Date: Jan. 4, 2018

(54) USER CONTROLLED PROFILES

(71) Applicant: Greydog Ventures Ltd., London (GB)

(72) Inventors: Laurence JOHN, London (GB); Dean SHEEHAN, Cambridge (GB); Dominic STROWBRIDGE, London (GB)

(21) Appl. No.: 15/545,497

(22) PCT Filed: Jan. 22, 2016
(86) PCT No.: PCT/EP2016/051340

§ 371 Date: Jul. 21, 2017

Related U.S. Application Data
(60) Provisional application No. 62/106,290, filed on Jan. 22, 2015.

(51) Int. Cl. G06Q 30/02; G06F 21/62; G06F 17/30

(52) U.S. Cl. CPC G06Q 30/0271; G06Q 30/0277; G06F 17/30867; G06F 21/6245

(57) ABSTRACT

Disclosed herein is a computer-implemented method for obtaining one or more offers for a user, the method comprising a secure computer environment within a computing system: receiving personal data of a user that has been authorised for use by the user and is associated with a confirmed user preference of the user, receiving offer data from one or more third party offer providers, generating one or more offer results in dependence on the offer data and personal data, and outputting the one or more offer results Advantageously, the personal data contained within a user's profile that is used to obtain offers or other beneficial services does not need to be transferred to the providers of these offers or other beneficial services as the mechanism to identify relevant offers or other beneficial services is managed through a sandbox mechanism.

### FIELD

The present invention relates to the generation, use, control and management of digital user profiles. User profiles are generated that comprise personal information of a user as well as preferences of the user. The user confirms the information contained in their user profile and is able to control what information is used and shared with other parties. Advantages include increased security of a user's personal data as well as more accurate results when a user's profile is used to interact with a service provider, for example to match a user with offers from third parties. The user experience is also improved as the generation, updating and provision of the user profile is largely automated and a user can easily use the user profile to personalise their activities.

### BACKGROUND

It is known for service providers to generate and maintain a user profile for each of the users of their service. Each user profile comprises a record of some, or all, of the data that can be determined from the user's interactions with the service. A user profile provides additional context to the interactions with a user and allows a service provider to personalise the experience for each user.

There is no universally accepted way of generating a user profile that represents personal data and preferences of a user. In addition, there is no single accepted repository for a user's personal data.

User profiles are typically independently generated by each of a plurality of service providers, with the format of the user profiles being specific to each service provider where that profile is also entirely private or partially private from the end user. This results in the user profiles being vertically separated and the data within the separate profiles not being shared and utilised effectively. For example, to generate a representation of an aspect of a user's general lifestyle and nutrition, it is desirable to combine a user's food purchase information with information about their exercise. However, it is very difficult for a user to obtain the relevant information that may be contained in user profiles held by the separate entities of a supermarket, credit card provider, gym provider and exercise monitor, and so automatically generating results from a combination of these user profiles is not practically possible.

There are initiatives by some governments to encourage service providers to make personal information available in machine readable formats for users to easily access (e.g. Midata initiative in the UK and Mes Infos in France). However, most service providers are reluctant to make all of their customer data easily available for users as this may compromise a business advantage that the service provider has. Accordingly, service providers that have made personal data of users available have done so with parts of the personal data redacted and used formats that have limited use (e.g. PDF files or CSV formats) and the download process is deliberately made obscure.

The use of independently generated user profiles also experiences the additional problem of the separate profiles being difficult to keep up-to-date. For example, if a user changes their home address, the user is required to register the change with each service provider, instead of being able to go to one place and update all their user profiles at once.

The use of independently generated user profiles also means that a user wastes a great deal of time when shopping around for different products and services. They will be required to enter their preferences repeatedly, often in different formats, when they are looking for the same product or service. Price Comparison Websites are an attempt to alleviate this problem, but they typically only represent a fraction of all suppliers, so a user still needs to interact with a number of different service providers to check all offers. Price Comparison Sites and more generally Search Engines will also only return published offers and are not able to generate competitive offers in real time.

In order to alleviate some of the difficulties associated with creating and managing a plurality of different user profiles for a user, some service providers have made their authentication and profile management capabilities available on a horizontal or federated basis (eg Facebook Connect, Google Single-Sign-On, Twitter). This allows a user to have one username and password that is used to access a wide range of services. As well as authentication, parts of the user's profile, such as location, email address and contacts, can also be shared. However, a user often has very limited means of controlling which aspects of their profile are shared. A user typically has to accept what a service requests in order to use that service. Users also have to accept that the provider of authentication and profile management is able to track their activity across a range of services, even if this is against a user's wishes.

Other examples of horizontally available user profiles are the payment profiles provided by banks and other service providers like Paypal. These are highly distributed across many different service providers, enabling users to use the same billing details wherever they may be. However, the information generated by these transactions is not made readily available to the user. In addition, the companies behind these payment profiles often go on to sell payment history to data exchanges without a user's knowledge or consent.

Some service providers, in particular online publishers, don't have direct interaction with a user. However, the service provider may still attempt to create a user profile for each user by using cookies to identify the user and to track the user's behaviour. The obtained data is then used to infer preferences of the user whilst the user interacts with their service. These inferred user preferences are then used to personalise the services offered to the user. Such inferred preferences are often inaccurate as they are based on only the small amount of a user's personal data that the service provider was able to capture. For example, a news site might note that a user reads a story about a celebrity and therefore infer that the user is interested in all celebrity stories. However, the user may have gone to school with this particular celebrity and this is the only reason why the user read the story. The inferred user preference would therefore be incorrect as the user may not be interested in other celebrity stories at all.

Data Exchanges (e.g. Audience Science, Blue Kai and Acxiom) are companies that provide user profiles to service providers. Data is collected by technology that follows users whilst they browse the internet on their computers and smartphones. Data may also be bought from various sources, such as the above-described payment providers, and combined with collected data. As data protection laws require personal data to be anonymised, combining data from different sources is difficult and often relies on statistical matching. There is also a lot of unease amongst users for service providers and other organisations to be tracking the user's online behaviour without the user's consent or even knowledge. Many users now use evasion tactics to avoid their online activities being tracked, such as blocking cookies or using false email addresses. This results in inferred user profiles being patchy and inaccurate. Online advertising platforms are frequent customers of Data Exchanges. They use the inferred preferences in profiles to decide which adverts to show to online users. Their very low success rates are partly a result of the inaccuracy of these inferred user profiles.

There are companies, sometimes referred to as ‘infomediaries’, which offer services that enable users, within restrictions, to manage user profiles of themselves. These companies fall into three main categories:
i) Data miners. These service providers encourage users to upload lots of personal information from different sources in return for some analytical service. For example, Mint, OnTrees and Money Dashboard encourage users to upload financial transactions from banks, credit cards and savings, in return for spending analysis and easier money management. Strava encourages fitness enthusiasts to upload exercise activity to analyse and compare with others. These service providers will then typically mine the user's information and attempt to sell them items, like new savings or fitness products, regardless of whether the user wants to be approached with such offers. They may also sell data to Data Exchanges.
ii) Advertising profilers (e.g. Datacoup, Qustodian and Handshake). In order to address the problem of inaccurate user profiles, some service providers have attempted to encourage users to create accurate profiles that can be sold to advertisers. The users are often encouraged with a share of the proceeds. However, better advertising is not generally seen as a big enough benefit in itself and the likely revenue is not large, so these services have had limited success. In order for an accurate profile to be generated and maintained, significant time and effort can be required of the user and so the user experience can be poor.
iii) Digital vaults (e.g. Personal.com and MyDex). Some services have developed platforms that enable a user to save their profile information in one place, from where it can be selectively shared with other services. These service providers also provide strong assurances that they will not use the user's information for any purpose other than those clearly stated. However, the profile information is substantially static and is information such as a user's address, education and work history and account details with different suppliers. The information can be useful for filling in forms but not for determining more advanced aspects of a user profile, such as a user's preferences.

Some of the horizontally available profile providers have responded to consumer pressure and given users access to their automatically generated user profiles. For example, Google Ad Settings and Acxiom's About-The-Data.com initiative, give users access to the inferred data collected by these service providers and the ability to edit that information. However, these activities are effectively means for verifying and collecting even more information on users rather than actually giving management and control of a user profile to users.

The types of information held within user profiles varies enormously. At one end of the spectrum are data points that are fixed or at least change either infrequently or predictably, such as sex, age, address and dietary preferences. At the other end of the spectrum are data points that change frequently, which are either factual, such as exercise activities and internet usage, or more ephemeral, such as a user's preferences, wishes and intentions. It is often difficult to capture the latter accurately and they are difficult to manage without a user's co-operation, as inferences are often wrong and at least some required personal data may not be available. The user's consent is also a critical component of these intentions. Much has been written about ‘intention broadcasting’ (a term coined by Doc Searles in 1999, with his book ‘The Clue Train Manifesto’ and follow-up ‘The Intention Economy’ in 2012) and the benefits for both users and service providers. However, no full solutions have been realised yet.

A fundamental problem with a user profile is that, once any data has been shared with another entity, that entity now has a copy of the data and they may do anything with it. Of course, terms and conditions may apply, but fundamentally, a level of trust is needed between the data sharer and the receiving party that these terms and conditions will be adhered to. Attempts have been made to develop digital protocols that would enforce the adherence of certain rules with a particular data set. For example Digital Rights Management continues to be used by the entertainment industry to limit the use of digital assets, but the very fact that those assets are delivered to a third party, typically an user, means that they are vulnerable to misuse.

The field of user profile management is crowded with many different attempts to create digital representations of users in order to personalise online services. However, where these are not managed by the user, they can be inaccurate, incomplete and do not include the user's consent. Of the known implementations of user profiles that allow user management, some are not aligned with user interests and others are limited in their applicability. The user managed profiles can also require substantial time and effort from the user to be maintained up-to-date. All existing implementations suffer from the fundamental problem that once data is shared, it is in the hands of the service provider and there are no guarantees that the service provider will not exploit the user's profile data in unauthorised ways.

### SUMMARY

According to a first aspect of the invention, there is provided a computer-implemented method for generating a user preference profile, the method comprising: obtaining, over a network, personal usage data of a user from one or more third party personal data sources, wherein each personal data source comprises personal usage data associated with actions and/or behaviours of a user; generating one or more inferred user preferences in dependence on an analysis of the obtained personal usage data; receiving confirmation from the user that at least one of the inferred user preferences is an actual user preference; and storing the user confirmed inferred user preferences in a user preference profile.

An aspect of the invention includes providing a computer-implemented method for generating a user preference profile, the method comprising: obtaining user preferences from a user, either directly or through obtaining personal usage data of a user from one or more third party personal data sources, wherein each personal data source is configured to provide personal usage data associated with actions and/or behaviours of a user; generating, for user preferences based on personal usage data, one or more inferred user preferences in dependence on an analysis of the obtained personal usage data; receiving confirmation from the user that at least one of the inferred user preferences is an actual user preference; and storing the user confirmed inferred user preferences in a user preference profile.

Preferably, the user preferences stored in the user preference profile are manageable by the user, such that a user can edit or delete the user preferences.

Preferably the method further comprises: receiving one or more user preferences that have been specified by the user; and storing the one or more user specified user preferences in the user preference profile.

Preferably, each user preference is one or more of an intended action by the user, potential future action by the user, a service for use by the user and an offer from an offer provider.

Embodiments include each user preference being content to describe an intended action, the context around the generation of a user preference and the consent of the user for service providers to act on a preference.

Preferably the method further comprises updating the user profile by obtaining further, or updated, personal data of the user; and determining if there are any new inferred user preferences in dependence on an analysis of the further, or updated, personal data and, for each new inferred user preference, storing the new inferred user preference in the user preference profile in dependence on confirmation received from the user.

Preferably, the method further comprises updating the user profile by: obtaining further, or updated, user preferences, either directly or inferred from personal data of the user; and determining if there are any new user preferences either directly or in dependence on an analysis of the further, or updated, personal data and, for each new user preference, storing the new user preference in the user preference profile in dependence on confirmation received from the user.

Preferably the method further comprises updating the user profile by obtaining further, or updated, personal data of the user; determining, in dependence on an analysis of the further, or updated, personal data, if there are any expired user preferences stored in the user preference profile; and removing any expired user preferences from the user preference profile.

Preferably the method further comprises generating one or more expected user preferences by analysing the personal data; and storing the one or more expected user preferences in the user preference profile.

Preferably the method further comprises storing personal data of the user in the user preference profile.

Preferably, said step of receiving confirmation from the user that one or more of the inferred user preferences are actual user preferences comprises: sending the one or more inferred user preference to a user system of the user for display to the user; and receiving confirmation that one or more of the inferred user preferences are actual user preferences in dependence on one or more user inputs to the user system in response to the displayed one or more inferred user preferences.

Preferably the method further comprises receiving, from the user, personal data of the user for obtaining the personal usage data of the user of one or more third party personal data sources.

Preferably, the generation of one or more inferred user preferences is also dependent on data associated with the context of the obtained personal usage data.

An aspect of the invention includes a method of generating a personal information document, the method comprising: generating a user preference profile according to the method of the first aspect; using the user preference profile to obtain personalised offers for a user and/or personalised advice; and storing the generated user preference profile and obtained personalised offers and/or personalised advice in a personal information document.

An aspect of the invention includes a computing system configured to implement the method of the first aspect.

An aspect of the invention includes a computer program that, when executed by a computing system, causes the computing system to perform the method of the first aspect.

According to a second aspect of the invention, there is provided a computer-implemented method for generating a user personalised webpage, the method comprising: obtaining a specification of personal data that is required to create a personalised webpage for a user; obtaining, from one or more personal data sources of the user, personal data of the user in dependence on the specification; receiving authorisation from the user to use at least some of the obtained personal data of the user; and enabling a personalised webpage to be generated in dependence on the at least some of the personal data of the user that has been authorised for use by the user.

An aspect of the invention includes a computer-implemented method for generating a user personalised webpage, the method comprising: obtaining user preference profile data for creating a personalised webpage for a user; receiving authorisation from the user to use at least some of the obtained user preference profile data of the user, wherein the user is able to specify the context(s) under which the use of some, or all, of the user preference profile data is authorised for use; and enabling a personalised webpage to be generated in dependence on at least some of the user preference profile data of the user that has been authorised for use by the user.

Preferably, said step of obtaining personal data, or user preference profile data, of the user comprises obtaining personal data, or user preference profile data, from a user profile and/or personal information document of the user.

Preferably, the personal data, or user preference profile data, is obtained from a user profile generated according to the method of the first aspect; and/or the personal data is obtained from a personal information document generated according to the method of the first aspect.

Preferably, at least some of the personal data is obtained from one or more third party data sources, wherein each of the one or more third party data sources comprises personal usage data associated with actions and/or behaviours of a user.

Preferably the method further comprises: displaying an initial webpage that is viewable by the user, wherein the initial webpage comprises a personalisation option that is selectable by a user; and performing said steps of obtaining a specification of personal data, obtaining personal data of the user, receiving authorisation from the user to use personal data of the user and generating a personalised webpage in dependence on the selection of the personalisation option by the user; and/or performing said steps of obtaining user preference profile data, receiving authorisation from the user to use the user preference profile data of the user and generating a personalised webpage in dependence on the selection of the personalisation option by the user.

Preferably the method further comprises authenticating the user in response to the user selecting the personalisation option that is displayed by the initial webpage.

Preferably, authenticating the user comprises either requesting the user to provide log-in details, or by means of an authentication token from a separate 3^{rd} party trusted identity source, such as Facebook™ or Google™.

Preferably, the initial webpage is generated by a first computing system; and at least the steps of obtaining a specification of personal data, obtaining personal data of the user and receiving authorisation from the user to use personal data of the user are performed by a second computing system that is remote from the first computing system and in communication with the first computing system.

Preferably, said step of obtaining a specification of personal data comprises one or both of the second computing system scraping the webpages generated by the first computing system and communication between the first computing system and the second computing system.

Preferably the method further comprises transmitting at least some of the personal data of the user that has been authorised for use by the user from the second computing system to the first computing system; wherein the personalised webpage is generated by the first computing system in dependence on at least some of the personal data of the user that has been authorised for use by the user.

An aspect includes one or more computing systems configured to implement the method according to the second aspect.

An aspect includes one or more computer program products that, when executed by one or more computing systems, cause the one or more computing systems to perform the method according to the second aspect.

According to a third aspect of the invention, there is provided a computer-implemented method for obtaining one or more offers for a user, the method comprising a secure computing environment within a computing system: receiving personal data of a user that has been authorised for use by the user and is associated with a confirmed user preference of the user; receiving offer data from one or more third party offer providers; generating one or more offer results in dependence on the offer data and personal data; and outputting the one or more offer results.

Preferably, the method further comprises providing one or more third parties with data in dependence on the personal data of the user such that the one or more third parties are able to determine offers in dependence on the user's personal data.

Preferably, the personal data of the user is a user preference profile of the user.

Preferably, the offer results are dependent on user configured preferences determining when, how and under what conditions the offer results are presented to a user.

Preferably, the received offer data comprises one or more externals that are each generated by a third party offer provider; and each of the one or more offer results is one of the externals comprised by the received offer data.

Preferably, the secure computing environment obtains the personal data from a personal data source of the user.

Preferably, the communication between the secure computing environment and the personal data source is restricted such that the secure computing environment is only able to read data from the personal data source.

Preferably, the personal data source is a user profile generated according to the method of the first aspect; and/or the personal data is obtained from a personal information document generated according to the first aspect.

Preferably, the only data output from the secure computing environment is comprised by received offer data by the secure computing environment.

Preferably, the secure computing environment is a sandbox.

Preferably, the one or more externals are URLs.

Preferably, the received offer data comprises algorithm and/or configuration data generated by the third party offer providers.

Preferably the method further comprises receiving further offer data from one or more third party offer providers; and updating the offer data used within the secure computing environment such that one or more offer results are generated in dependence on the further offer data.

Preferably the method further comprises generating proposals for presenting to a user in dependence on the one or more offer results.

An aspect includes a computing system configured to perform the method of the third aspect.

An aspect includes a computer program product that, when executed by a computing system, causes the computing system to perform the method of the third aspect.

According to a fourth aspect of the invention, there is provided a computer-implemented method for obtaining one or more offers from one or more third party sources of offers in dependence on a user preference, the method comprising: obtaining a user preference that comprises personal data of a user that is usable in the generation of offers in dependence on the user preference, wherein the user preference has been confirmed by a user as being an actual user preference and authorised by the user for use in obtaining offers; obtaining offers from one or more third party sources of offers in dependence on the user preference; and determining to store one or more of the obtained offers in dependence on a comparison of each of the one or more obtained offers and existing stored offers.

Preferably, the user preference is comprised by a user profile or personal information document.

Preferably, the user preference is obtained from a user profile generated according to the method of the first aspect; and/or the user preference is obtained from a personal information document generated according to the method of the first aspect.

Preferably the method further comprises repeatedly obtaining offers from one or more third party sources of offers; determining if any new obtained offers improve on existing stored offers by at least one attribute; and storing new obtained offers that improve on existing stored offers by at least one attribute.

Preferably, obtaining offers from one or more third party sources of offers in dependence on the user preference comprises providing the user preference to the third party sources of offers.

Preferably the method further comprises determining that the user preference is authorised for use in obtaining offers in dependence on authorisation received from a user.

Preferably the method further comprises providing third party sources of offers with data on existing stored offers.

Preferably the method further comprises determining if a group offer is available in dependence on said user preference and one or more user preferences of respective one or more other users.

Preferably, the method further comprises: obtaining user preferences from a plurality of users; generating aggregated data in dependence on the obtained user preferences; and sending the aggregated data to one or more third parties such that the one or more third parties can provide offers in dependence on the aggregated data.

Preferably, offers are presented to a user in dependence on third party offer conditions and/or user specified offer conditions.

Preferably the method further comprises generating a user personalised webpage in dependence on one or more obtained offers.

An aspect includes a computing system configured to implement the method of the fourth aspect.

An aspect includes a computer program that, when executed by a computing system, causes the computing system to perform the method of the fourth aspect.

### LIST OF FIGURES

FIG. 1 shows a system according to embodiments of the invention.

FIG. 2 shows processes performed by the first embodiment of the invention.

FIG. 3 shows a personal information document according to the first embodiment of the invention.

FIG. 4 is a flowchart of the first embodiment of the invention.

FIG. 5 is a flowchart of the second embodiment of the invention.

FIG. 6 is a flowchart of the third embodiment of the invention.

FIG. 7 shows a system according to the fourth embodiment of the invention.

FIG. 8 shows processes performed by the fourth embodiment of the invention.

FIG. 9 shows a process performed by the fourth embodiment of the invention.

FIG. 10 is a flowchart of the fourth embodiment of the invention.

FIG. 11 is an exemplary display screen of a user interface according to embodiments of the invention.

FIG. 12 is an exemplary display screen of a user interface according to embodiments of the invention.

FIG. 13 is an exemplary display screen of a user interface according to embodiments of the invention.

FIG. 14 is an exemplary display screen of a user interface according to embodiments of the invention.

FIG. 15 is an exemplary display screen of a user interface according to embodiments of the invention.

FIG. 16 is an exemplary display screen of a user interface according to embodiments of the invention.

### DESCRIPTION

Embodiments of the invention improve on known techniques of generating and using a profile of personal details and preferences of a user. According to embodiments, a user is provided with full control of their user profile. Dynamic personal data of a user is automatically obtained and used to infer preferences of a user. However, the inferred user preferences are not stored in the user profile unless confirmation has been received from the user that the inferred preferences are correct. The preferences then become active. The obtaining of personal data and inferring of preferences is automatically repeated so that the user profile is a dynamic user profile and therefore always substantially up to date and accurate. In addition, the user is in full control of what personal data and preferences within their user profile are used.

Advantageously, the user controls the data within their personal profile. The used user profile therefore accurately corresponds to a user's present active preferences when the user profile is used for obtaining offers or other beneficial services for the user. The user experience is also improved over known techniques as a user is not required to manually enter and update a large amount of their personal data. The generation and updating of the user profile is largely automatically performed, with little user input required, whilst the user remains in full control of their personal profile.

Embodiments also improve the effectiveness of how a user profile is used. According to an embodiment, a user navigates to a webpage that displays offers that have not been personalised to the user. By the user selecting an option on the displayed webpage and authorising the use of specific aspects of their personal data, the displayed offers are automatically updated to offers personalised to the user. Active preferences can also be captured from the personalised webpage, incorporating a combination of personal information and contextual information from the webpage.

According to another embodiment, a plurality of offer providers 103 are arranged to competitively match their offers to the active preferences of a user rather than a user directly obtaining an offer from each of the offer providers 103. Offer collection may be triggered by parameters in the active preference, such as a contract renewal date or a price falling below a specified level. User experience is improved since a plurality of the most appropriate offers are brought to a user rather than the user approaching the offer providers 103. Offer providers 103 can be notified of an active preference through any network, including direct connections and advertising systems.

Embodiments also improve the security of a user's personal data. Personal data is only provided to other parties if specific authorisation from the user is received. In addition, embodiments include the use of a trusted personal data system, which is independent from offer providers 103, hosting a secure sandbox for matching/comparing a user profile to provided offers. The inputs to the sandbox are data and algorithms from offer providers 103 and personal data of a user. The output from the secure sandbox is a result of the matching that does not comprise the personal data. Advantageously, no personal data of the user is ever provided to offer providers 103.

Specific embodiments of the invention are described in more detail below.

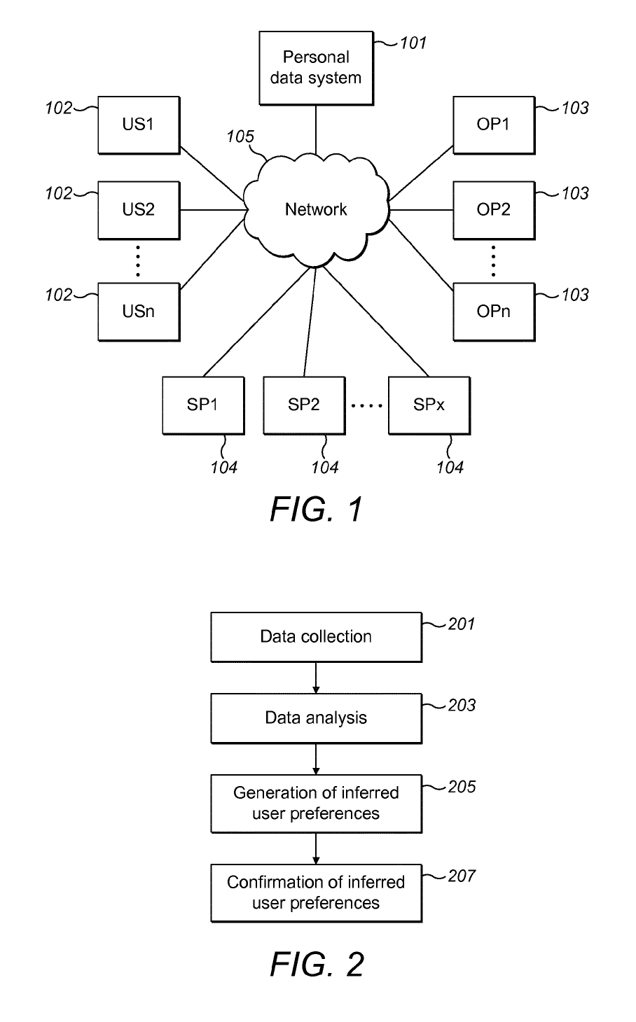

FIG. 1 shows a system according to embodiments. The system comprises a plurality of user systems US1, US2, . . . USn 102; a plurality of offer providers OP1, OP2, . . . OPN 103; a plurality of service providers SP1, SP2, . . . SPx 104; a personal data system 101 and a network 105.

Each of the user systems 102 is any user system 102 for supporting electronic communications and interactions with a user. Examples of user systems 102 include mobile telephones, smart phones, laptop computers, tablets desktop computers and other computing systems.

Each of the offer providers 103 is a server/computing system capable of providing offer data, and any other data, required for generating an offer for presenting to a user. A transaction between the offer provider 103 and a user can occur if a provided offer is accepted by a user.

Each of the service providers 103 is a server/computing system that provides a service to at least one of the users. The service provider 104 is a personal data source for the user with the personal data being a record of the user's use of the service. For example, a service provider 104 may be the provider of the user's mobile telephone. The personal data held by such a service provider 104 would be a record of the user's mobile telephone usage. Other examples of service providers 104 include a financial service provider, such a credit card provider, car insurance provider, transport system, the gym that the user uses or even a specific shop. Embodiments are contemplated for use with any type of service provider that a user uses.

The network supports all of the electronic communication between the user systems 102, the offer providers 103, the service providers 104 and personal data system. Although not shown in FIG. 1, also present in the system are base stations and other well-known components of communications systems for supporting electronic communication between wireless and wired devices.

The personal data system 101 is a server/computing system that supports electronic communications with the user systems 102, offer providers 103 and service providers 104. The personal data system 101 comprises memory for storing user profiles and other records for each of the users. The personal data system 101 also comprises processors and other well-known computing components for processing data to perform operations such as inferring user preferences and computing offers in dependence on algorithms.

According to known techniques, some or all of the communications between the user systems 102, offer providers 103, service providers 104, personal data system 101 and network may be encrypted to enhance the security of the data transfer.

According to a first embodiment, an accurate profile of a user's personal data, including the user's preferences, is generated by the personal data system 101. The user profile can be used to obtain offers for services or products that a user requires. Preferably, the personal data system 101 generates a personal information document 301 that comprises the user profile, as well as one or more of obtained offers for the user, expected future preferences of the user and advice and suggestions for the user.

The processes of the first embodiment are described with reference to FIG. 2.

A user signs up to the personal data system 101 and the personal data system 101 creates an account for the user. The user is issued with a username and password for logging into their account with the personal data system 101.

The user provides the personal data system 101 with their static, or substantially static, personal data, such as their birthdate, sex, home address and any other details that the user is prepared to have included in a personal profile of themselves. Alternatively, the user may only provide sufficient information for this personal data to be automatically obtained from one or more personal data sources by the personal data system 101. The user is not at this stage authorising the use of any of the data included in their user profile and the user can later ensure that specific data within their user profile is not used to generate offers for the user or ever provided to third parties. The user also provides the personal data system 101 with details of service providers 104 that the user uses. As described above, these may be the providers of any service that a user uses and has an electronic record of the use of their service by the user. The details provided to the personal data system 101 include the personal data of the user that allows the personal data system 101 to directly log onto the user's accounts, or otherwise integrate and/or communicate, with each of the service providers 104 and to obtain the user's usage data of the service provider as well as any other personal data of the user that is held by the service provider. The user may provide these details by logging onto the service provider via the personal data system 101.

As shown in step 201 of FIG. 2, the service provider performs a data collection operation to obtain the personal data of the user from each of the service providers 104.

For each of the service providers 104, this process may be performed automatically or in dependence on authorisation by the user. For example, it may be detected that the user has viewed the website of mobile telephone service provider and this may act as a trigger for automatically obtaining the user's current mobile telephone usage records. Alternatively, the service provider may send, to the user system 102 of the user, a request for permission to obtain personal data from a particular service provider. Alternatively, a user is not actively approached with an authorisation request and authorisation is only obtained when a user logs into their account with the personal data system 101 and then provides authorisation to obtain personal data from one or more service providers 104.

Accordingly, in step 201, personal data that describes the usage of a service or product by a user is collected from communication between the personal data system 101 with third party systems. For example, the process may collect mobile telephone usage information from the portal, or API, of the mobile telephone service that the user has a contract or facility with. Each of the collection processes may be executed once or configured to be executed periodically to ensure that recent, or live, personal data is obtained. Data collection also includes obtaining, if possible, context data that relates to the context of a user's interactions.

After data collection operations have been performed for one or more service providers 104, the personal data system 101 performs data analysis operations as shown in step 203. A user's personal data is analysed to derive summary information pertinent to the provision of one or more services or products. For example, the analysis may derive average usage statistics for mobile phone usage covering number of texts, voice minutes and data gigabytes used per period of time. The analysis is not restricted to using personal data from only one service provider and the analysis may use personal data from more than one service provider and/or the user's substantially static personal data. Preferably the context of the user's personal data is also determined. The context may, for example, be determined from a website where a user's personal data has been used. For example, a user may view a webpage that sells new mobile telephones. The context of the webpage that the user is viewing is therefore ‘new mobile telephones’.

In step 205, the personal data system 101 infers user preferences in dependence on the result of the data analysis and, preferably, determined context data. For example, the collection of mobile phone data may determine that the user is still within their current contract and that the contract will come to an end in two months time. The user preference to change mobile telephone provider to a cheaper deal given a user's actual usage in two months time is therefore inferred. If the context data of ‘new mobile telephones’ is also associated with the user, the more specific preference that a user would both like to be offered a more appropriate mobile telephone contract and also be offered a new mobile telephone with the contract may therefore be inferred. Data from the user's financial services provider may also be used to generate the even more specific preference of what price range of mobile telephone a user would be interested in.

In step 207, for each of the inferred user preferences, the personal data system 101 obtains confirmation from the user that the inferred user preference is an actual user preference of the user. Each of the inferred preferences is sent from the personal data system 101 to the user system 102 and displayed to the user. The user then confirms, modifies or rejects each of the inferred preferences with easy interactions with the user system 102, such as selecting one of an ‘Accept’, ‘Reject’ and ‘Modify’ option displayed for each inferred user preference. The user's response to each inferred preference is then sent back from the user system 102 to the personal data system 101. Each inferred user preference is only stored in the user profile of a user if it is confirmed as an actual user preference by the user. Inferred user preferences that have been modified and approved for use by the user are sent back in their modified form to the personal data system 101 where they are treated as confirmed user preferences and stored in the user profile.

Accordingly, the personal data system 101 generates a user profile that comprises static, or substantially static, personal data of a user as well as dynamically generated user preferences that are confirmed by the user as being actual user preferences. The user profile may also include user preferences that are specified by the user and provided to the personal data system 101 from the user system 102 rather than being inferred.

Advantageously, a single user profile is generated that accurately corresponds to a user's current details and preferences. Accurate user preferences can be generated in dependence on a user's personal data from different service providers, the context of the user's interactions and the user's consent.

Preferably, the personal data system 101 generates and stores a personal information document 301 for each user. The personal information document 301 comprises some, or all, of a user's personal data, including the user's preferences, that are present in the user profile. The user profile itself may form part of the personal information document 301 and not be stored separately.

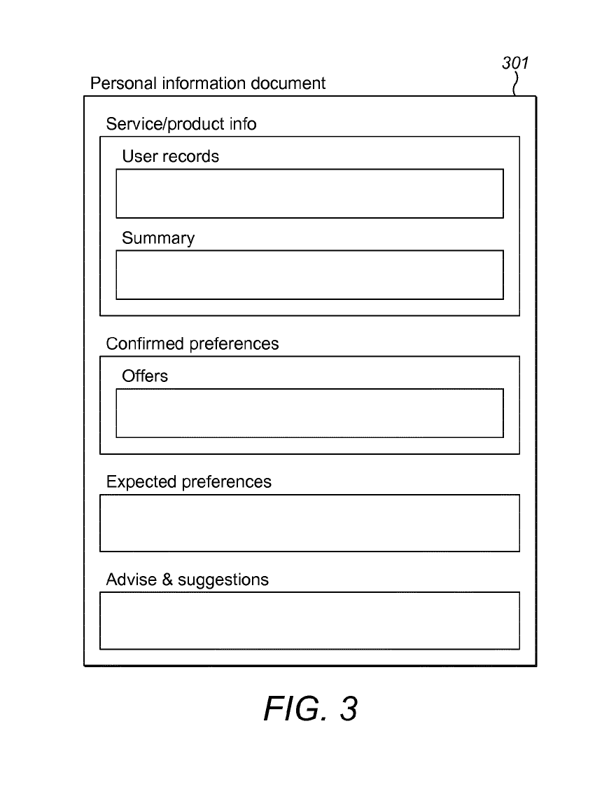

An example of a personal information document 301 for a user according to an embodiment is shown in FIG. 3. The document comprises one or more of service/product information, confirmed preferences, expected preferences and advice/suggestions.

The service/product information comprises usage records that are the above-described personal data that describes the usage of one or more services or products by the user. It also comprises summaries of the analysis of the usage records.

The confirmed preferences are the inferred user preferences that were confirmed as being actual user preferences by the user. Also stored in this part of the personal information document 301 may be offers, or deals, that are the offers of services and/or products from third parties to the user. Offers relating to a user's confirmed preference are automatically collected by the system through communication and/or integration with publically available information sources (such as websites that publish deals), off-book deals through communication and/or integration with third party providers of brands via advertisement networks, advertisement exchanges and direct communication and/or integration with third party providers of offers. The later described techniques of the fourth embodiment may also be used to generate offers.

Expected preferences are generated by analysing the confirmed user preferences and/or a user's personal data. Expected preferences are user preferences that are determined as being likely to occur. Unlike confirmed user preferences, the user is not directly involved in the creation of the expected preferences. The personal data system 101 infers expected preferences, that will typically relate to future events. The expected preferences require future confirmation from the user before they are used. For example, once a user has accepted an offer to purchase a new mobile telephone contract that lasts one year, it is possible to determine the expected preference that when the user's newly acquired mobile telephone contract has expired in one year's time, a new mobile telephone contract will be required. Expected preferences require confirmation from the user in order for them to be turned into active preferences. Preferably, a trigger is set for seeking confirmation from a user at an appropriate point in time or under other conditions. For example, it may have been determined that a user, or their partner, is pregnant or had a child. The expected preference of the user requiring a larger car and/or house may be determined. The trigger for requesting the user to confirm the expected preference is the further determination that the child is now above the age of three and/or that the user has received an increase in salary.

Advice/suggestions for the user from third parties may also be stored in the personal information document 301. These are records that are generated by the processing of some or all of the data within a user's personal information document 301 by algorithms of third parties. Such processing is preferably performed using the techniques of the fourth embodiment, described later in the present document.

Advantageously, the personal information document 301 provides a single source of accurate personal data of a user, including actual and expected preferences of the user as well as offers and advice provided to the user from third parties.

For both the user profile and the personal information document 301 the above-described processes of obtaining personal data of the user, inferring preferences of the user, confirming the inferred preferences by the user, obtaining offers, generating expected preferences, confirming expected preferences and obtaining advice suggestions are automatically repeated so that the user profile and personal information document 301 are maintained up to date with accurate personal data. All of the generated inferred user preferences, expected user preferences, offers and advice/suggestions are checked against the existing corresponding data stored in the user profile and/or personal information document 301 and deleted if already present in the user profile and/or personal information document 301. This prevents a user being presented with the same preference, offer and advice/suggestions twice and data in the user profile and/or personal information document 301 being duplicated. The personal data system 101 also automatically determines if the user preferences, offers and advice/suggestions in the user profile and/or personal information document 301 are still relevant to a user and delete any that are determined to not be relevant any more. For example, the personal information document 301 may have comprised the user preference that a user would like to change their mobile telephone contract. If it is later determined that a user has changed their mobile telephone contract, the user preference to change the user's mobile telephone contract would be deleted from the personal information document 301 as well as resulting offers regarding mobile telephone contracts that were also present in the personal information document 301.

All user preferences, that have been inferred or directly provided by a user, are fully manageable by the user. The user can edit and/or delete any user preferences at any time. Accordingly, the method for storing the user's preferences and personal data enables the user to have total effective ownership and control over their own data. Access to this data is authorised to the system at the user's discretion, and can be revoked at any time. The storage method may be provided by a 3rd party service (e.g. DropBox™), may reside on the user's computer (e.g. a browser cookie), or may be managed by the service by proxy, fulfilling the requirements for the user's control of their own data detailed above.

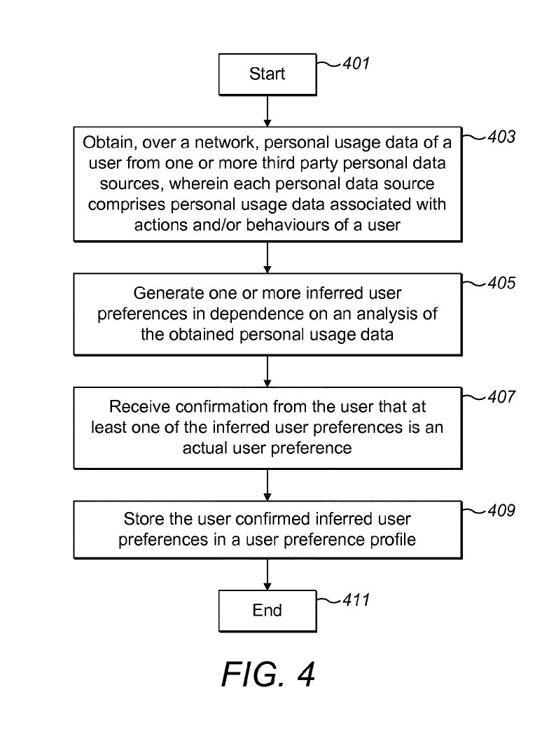

FIG. 4 shows a flowchart of a computer implemented process for generating a user preference profile according to the first embodiment.

In step 401, the process starts.

In step 403, personal usage data is obtained, over a network, of a user from one or more third party personal data sources, wherein each personal data source comprises personal usage data associated with actions and/or behaviours of the user.

In step 405, one or more inferred user preferences are generated in dependence on an analysis of the obtained personal usage data.

In step 407, confirmation from the user is received that at least one of the inferred user preferences is an actual user preference.

In step 409, the user confirmed inferred user preferences are stored in a user preference profile.

In step 411, the process ends.

According to a second embodiment, the personal data system 101 is used to personalise webpages viewed by a user. A user navigates to a webpage that may be showing, for example offers from car insurance providers. By selecting an option that personalises the webpage according to the personal data of the user, the webpage is re-launched with offers that have been generated in dependence on an accurate representation of the user's preferences. Advantageously, more relevant offers are presented to the user.

According to the second embodiment, a user browses to a third party's website. Displayed within the published content on the third party's website is a selectable option, such as a button, for commencing the process of personalising the webpage for a user.

The third party is preferably already a partner of the personal data system 101 and the displayed selectable option a result of action by the third party to include the displayed selectable option in the published content. Alternatively, there may be no existing relationship/link between the third party and personal data system 101 and the selectable option is injected into the published content through a proxy or browser extensions or through use of advertising inventory and advertising networks. These approaches do not require any cooperation of the third party website with the personal data system 101.

If a user does not select the button, then the user can continue to navigate the webpages of the third party, and other parties, without the displayed data being personalised to the user.

If the user chooses to make use of the personalisation option by selecting the button, then the user is presented with a request to enter, or verify, their login details to their account with the personal data system 101.

If the user does not know their login details, or does not want to use the login option, they can still personalise the webpages by guessing their personal information. This may not result in such an accurate personalisation but gives the user an approximation that may be good enough.

After the user has logged-in to the personal data system 101, the personal data system 101 communicates to the third party system via an API of the third party system and obtains the information required by the third party system for generating offers. Alternatively, the personal data system 101 may use scraping to extract required information from the displayed website. The third party systems that support and display the webpage may be either the same or separate systems from those that the personal data system 101 communicates with to obtain the required information for generating offers.

The personal data system 101 then obtains the personal data of the user for use in generating offers from the third party. The specific personal information that is obtained is dependent on the already obtained required information for generating personalised offers for the user. For example, if the website provides mobile telephone offers, the required personal data would include the usage records of the user's current mobile telephone.

If the personal data system 101 already has a user profile and/or personal information document 301 according to the first embodiment for the user, then the required personal information can be retrieved. For dynamic data, such as usage records, the personal data system 101 preferably automatically obtains the current usage records from the associated service provider to ensure that the most up to date data is used.

Alternatively, if the personal data system 101 does not already have a user profile and/or personal information document 301 for the user or the required data is from a new service provider that has not been used by the personal data system 101 to obtain personal data for this user before, the personal data system 101 sends a request to the user to provide log-in details to the service provider. The personal data system 101 then uses the provided log-in details to obtain the user's usage data from the service provider.

If the results of analysing the obtained personal data are not already available from a user profile and/or personal information document 301 for the user, the personal data system 101 performs an analysis of the personal data. For example, for mobile telephone usage data, the average usage across a number of dimensions (e.g. calls, texts and data) may be determined.

The personal data system 101 then generates a summary of the personal data that it intends to use in order to generate personalised offers from the third party. The summary is presented to the user and the user can amend the personal data in the summary and consent to all, or just specific parts, of the personal data being used. The user is therefore aware of what personal data will be used and provides consent for this data being used.

On receiving consent to use the user's personal data, the personal data system 101 arranges for the initially displayed webpage to be re-launched with content personalised to the user. This may be performed by the personal data system 101 providing the user consented personal data to the third party system and the third party system re-launching the webpage with the displayed results being generated in dependence on the provided personal data. Alternatively, the personal data system 101 may re-launch the website itself by using either filters set up via query parameters or browser/DOM/javascript manipulation of the third party system content.

Advantageously, a user can easily choose to view personalised offers and is in full control of the data used to generate the offers. The user experience is good because the option for a user to personalise a webpage is automatically provided to the user when the user requires it and the personalisation option can be quickly and easily selected by the user.

Embodiments include some or all the operations required to personalise a webpage being automatically performed. Embodiments include the personalisation of a webpage being performed without the user selecting the option for commencing the process of personalising the webpage for a user. The automatic personalisation may be the result of a user preference.

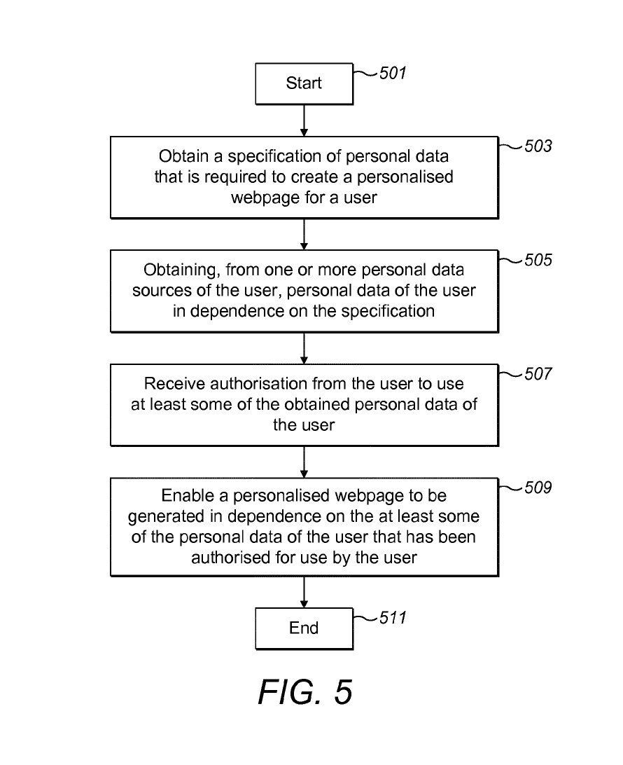

FIG. 5 shows a flowchart of a computer-implemented process for generating a user personalised webpage according to the second embodiment.

In step 501, the process starts.

In step 503, a specification of personal data is obtained that is required to create a personalised webpage for a user.

In step 505, personal data of the user is obtained from one or more personal data sources of the user in dependence on the specification.

In step 507, authorisation is received from the user to use at least some of the obtained personal data of the user; and

In step 509, the generation of a personalised webpage is enabled in dependence on the at least some of the personal data of the user that has been authorised for use by the user.

In step 511, the process ends.

According to a third embodiment, the personal data system 101 periodically seeks the most appropriate offers for providing to a user given the user's active preferences. The second embodiment operates in real time to provide a user with personalised offers that are currently published. Advantageously, the third embodiment is able to also provide users with better offers that were not published at the time that offers were first determined for the user or are only provided as off-book offers.

The personal data system 101 generates offers for each confirmed user preference according to the techniques as already described for the first embodiment. During the lifetime of each user preference, the personal data system 101 repeatedly, or continuously, obtains offers, or deals, from published websites, web services and other offer sources in dependence on the match/comparisons of the offer to the user preference.

Some of the found offers will have already been found by a previous search for offers and will already be included in the user's personal information document 301 for review by the user. The personal data system 101 therefore identifies these duplicate offers and filters them out to avoid a user being presented with the same offer twice.

For each new offer that is found, a determination is made as to whether or not to include the offer in the personal information document 301. Accordingly, the personal data system 101 determines if each new offer improves upon an existing offer in the personal information document 301 by at least one attribute and includes these offers in the personal information document 301. Any new offers that do not meet this requirement are not included in the personal information document 301.

The personal data system 101 then informs the third party sources of offers, either indirectly through advertisement-networks and/or advertisement-exchanges or directly through communication/integration with the third party system of the most competitive offer. Alternatively, the details of more than one, or all, of the offers in the personal information document 301 may be provided to the third party sources of offers. The offers are preferably provided in a manner such that their source is kept anonymous. The third party sources of offers, or their resellers, are then provided with the opportunity to provide an ‘off-book’ custom offer. Such offers may be generated following an auctioning, or reverse auctioning, process in order to ensure that a user is provided with competitive offers. Any such offers that are received are included in the personal information document 301 subject to meeting the above-described requirements of not duplicating an existing offer and improving on the existing offers by at least one attribute.

Preferably, the personal data system 101 supports a plurality of users and the personal data system 101 searches the user profiles and/or personal information document 301s of the plurality of users and identifies corresponding, or similar, user preferences amongst more than one user. When such a common user preference is found, the personal data system 101 then obtains group offers from the third party offer providers 103. Group offers are expected to improve, or at least match, individual offers and this can therefore result in better offers for a user being obtained. Any such group offers that are found are included in the personal information document 301. The record of the offer may indicate that it is only available subject to the condition of other users accepting the offer.

Preferably, the user is automatically notified whenever the offers in the personal information document 301 are updated.

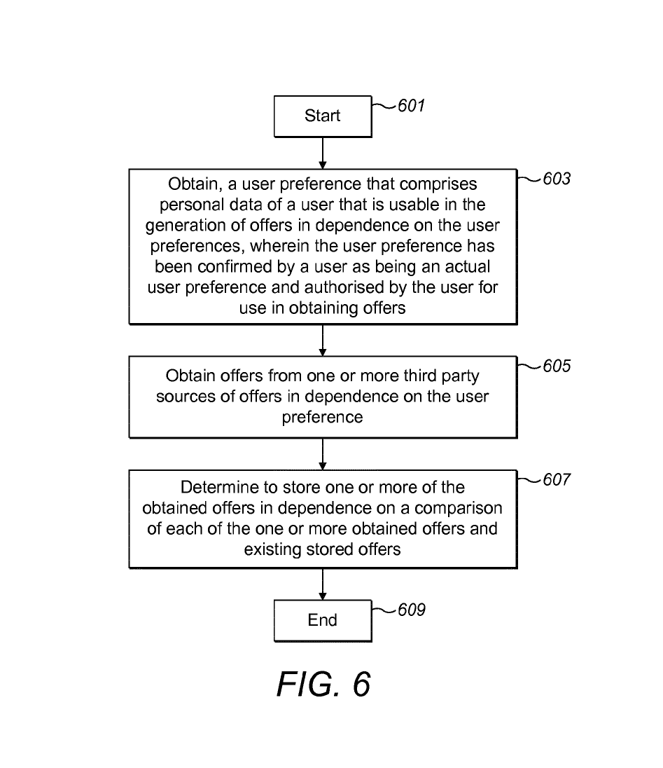

FIG. 6 shows a flowchart of a computer-implemented process for obtaining one or more offers from one or more third party sources of offers in dependence on a user preference according to the third embodiment.

In step 601, the process starts.

In step 603, a user preference is obtained that comprises personal data of a user that is usable in the generation of offers in dependence on the user preference, wherein the user preference has been confirmed by a user as being an actual user preference and authorised by the user for use in obtaining offers.

In step 605, offers are obtained from one or more third party sources of offers in dependence on the user preference.

In step 607, it is determined to store one or more of the obtained offers in dependence on a comparison of each of the one or more obtained offers and existing stored offers.

In step 609, the process ends.

According to a fourth embodiment, the personal data system 101 processes user preferences and compares offers to user preferences in a highly secure way that avoids compromising a user's personal data. The data required for the process is obtained by a secure computing environment 701, preferably a secure sandbox, provided within the personal data system 101. A user's personal data is not output from the secure computing environment 701 and the outputs from the secure computing environment 701 do not compromise the personal data

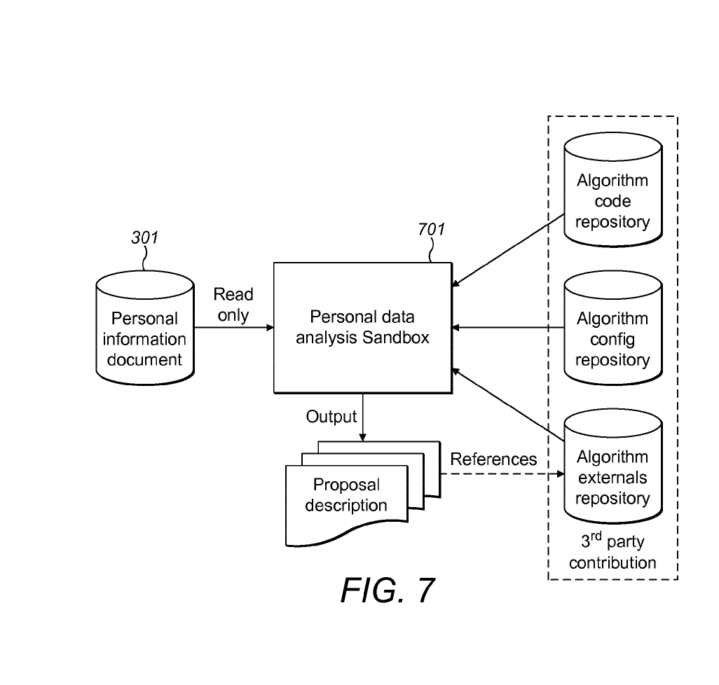

The fourth embodiment is described with reference to FIG. 7 to 9.

FIG. 7 shows a secure transient personal data analysis sandbox that is in communication with a personal information document 301, as generated according to the techniques of the previous embodiments, as well as offer data from third parties that are stored in an algorithm code repository, algorithm configuration repository and algorithm externals repository. The sandbox is also in communication with a proposal description that stores outputs from the sandbox.

In order for a third party to perform an analysis over a user's personal data without obtaining unrestricted access to that data, the personal data system 101 receives algorithms from third parties and these are stored in the service algorithm repository. The algorithms are brought into the transient sandbox for execution. The sandbox does not enable any network communication at this stage and this ensures the safety of the user's personal data.

The third party algorithms may be complemented with configuration data, that may also be contributed by the same third party that contributed the associated algorithm(s). The configuration data is stored in an algorithm configuration repository and provided to the third party's algorithm(s) within the sandbox when required.

The third party's also provide a set of externals with the algorithms. These are potential outcomes or outputs of the sandbox execution. The externals preferably are standard HTTP(S) URLs. These URLs are not be accessed during the sandbox execution and only form part of the output of processes performed by the sandbox, i.e. determining offers that the user may choose to access.

The sandbox has read-only access to a user's personal information document 301 and/or user profile. The sandbox is configured to process and make decisions based on third party algorithms, a user's personal data, its own configuration and the externals data.

The sandbox generates and stores an output proposal that contains text and/or images along with one or more references to the previously declared algorithm externals. Due to the pre-declaration of the externals, it is not possible for a third party's algorithm to dynamically construct an URL that includes, or otherwise encodes, facets of a user's personal data. The only external communication that can arise as a result of the sandbox execution is through reference to a pre-declared HTTP(S) URL.

A third party may update/change/remove their algorithms, configuration and externals periodically in order to ensure that current offers are generated.

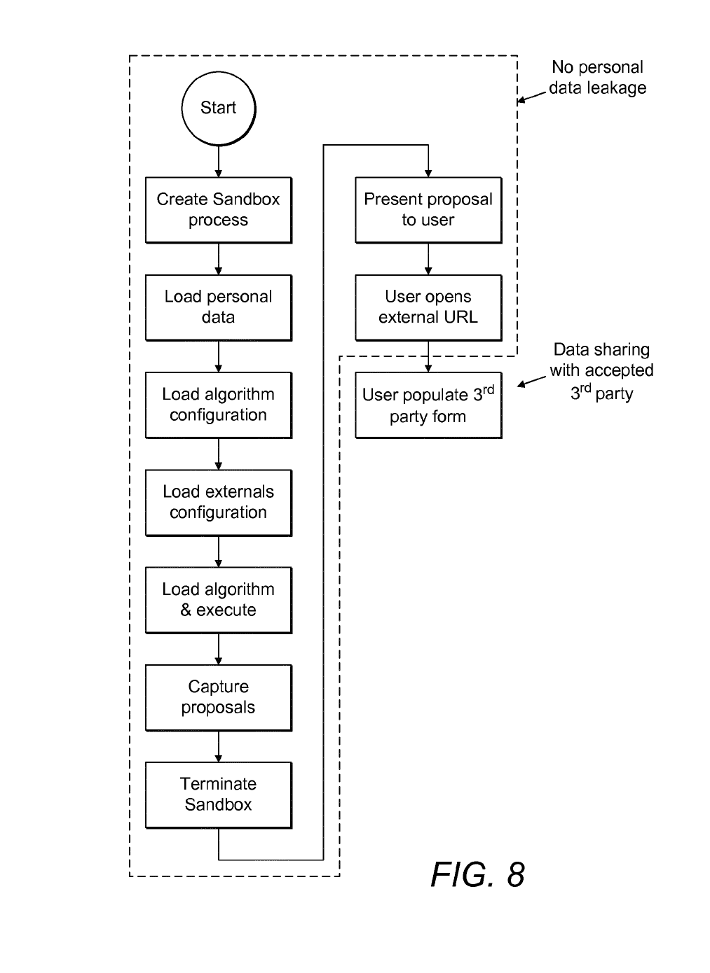

FIG. 8 shows the processes performed by the sandbox. Within the sandbox processes, no personal data is output from the personal data system 101 as no network connections are permitted. The only output from the sandbox processes are ‘proposals’ and these contain non-sensitive HTML text and GET HTTP URLs that refer to pre-defined URLs loaded into the algorithm externals repository.

When a user is presented with proposals, i.e. offers, that have resulted from a sandbox evaluation, no personal data is leaked as the URLs accessed are, once again, derived by reference to static pre-defined, pre-loaded, URLs.

If a user chooses to directly interact with a system identified by a URL, such as by filling in a webpage form, then personal data may be exchanged. However, this is due to direct interaction between the user and the target system and there is no loss of personal data by the operations of the personal data system 101.

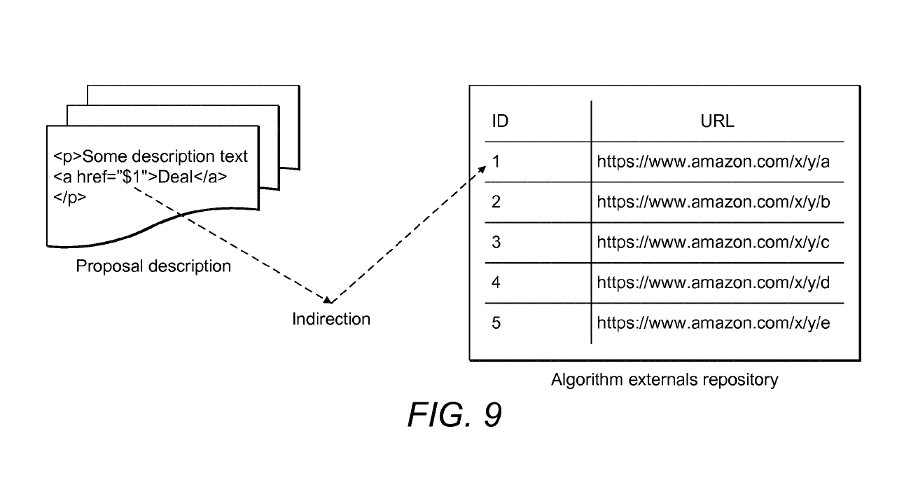

Proposals are the outputs obtained from a sandbox evaluation. As shown in FIG. 9, they are small HTML documents where URLs are validated, prior to presenting to a user as an offer, in order to contain only URL references made from static text that identifies a URL, by an ID, in the algorithm externals repository.

A third party algorithms externals repository is a table of IDs (as integer identifiers) versus URLs. The processing of a proposal, in preparation for presentation to a user as an offer, replaces the ID references within the proposal with the associated URL from the algorithm externals repository.

Advantageously, the provision of a user's personal data by the personal data system 101 to third parties is avoided during the processes for generating offers for a user.

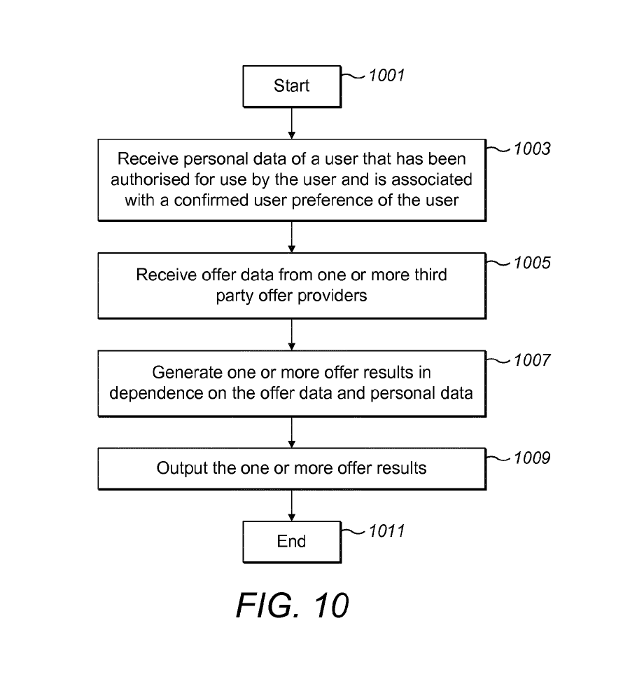

FIG. 10 shows a flowchart of a computer-implemented process for obtaining one or more offers for a user according to the fourth embodiment.

In step 1001, the process starts.

In step 1003, personal data of a user is received that has been authorised for use by the user and is associated with a confirmed user preference of the user.

In step 1005, offer data is received from one or more third party offer providers 103.

In step 1007, one or more offer results are generated in dependence on the offer data and personal data.

In step 1009, the one or more offer results are output.

In step 1011, the process ends.

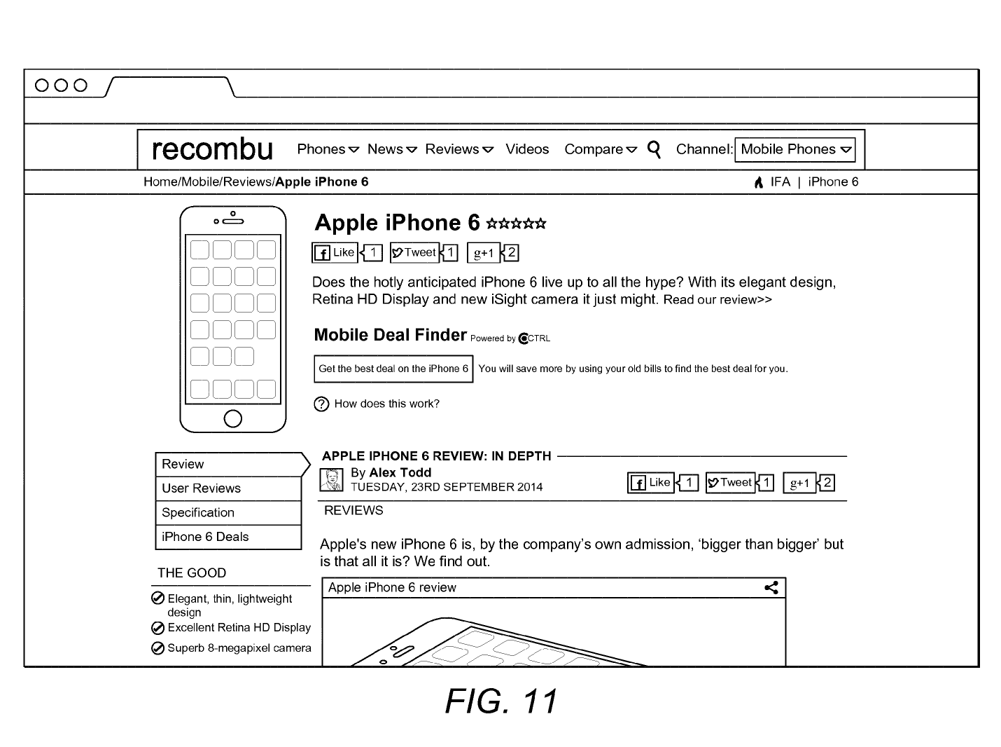

FIGS. 11 to 16 are exemplary display screens that demonstrate simplicity and efficiency of the user interaction with the personal data system 101 to obtain personalised offers.

FIG. 11 shows a example of a webpage of a third party. Displayed on the webpage is a button, labelled here as ‘powered by CRTLio®’, that is a selectable option for accessing a user's account with the personal data system 101.

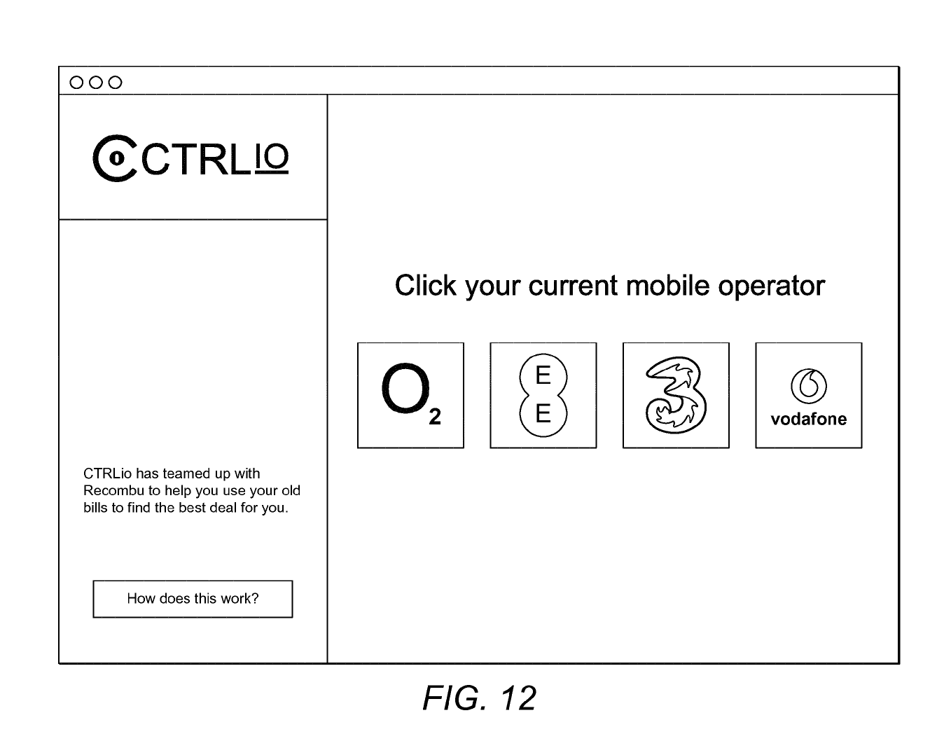

FIG. 12 shows what is displayed to the user if the personal data system 101 is required to obtain mobile telephone usage data of the user (in this example, the user profile did not already store this data however in preferred implementations it would).

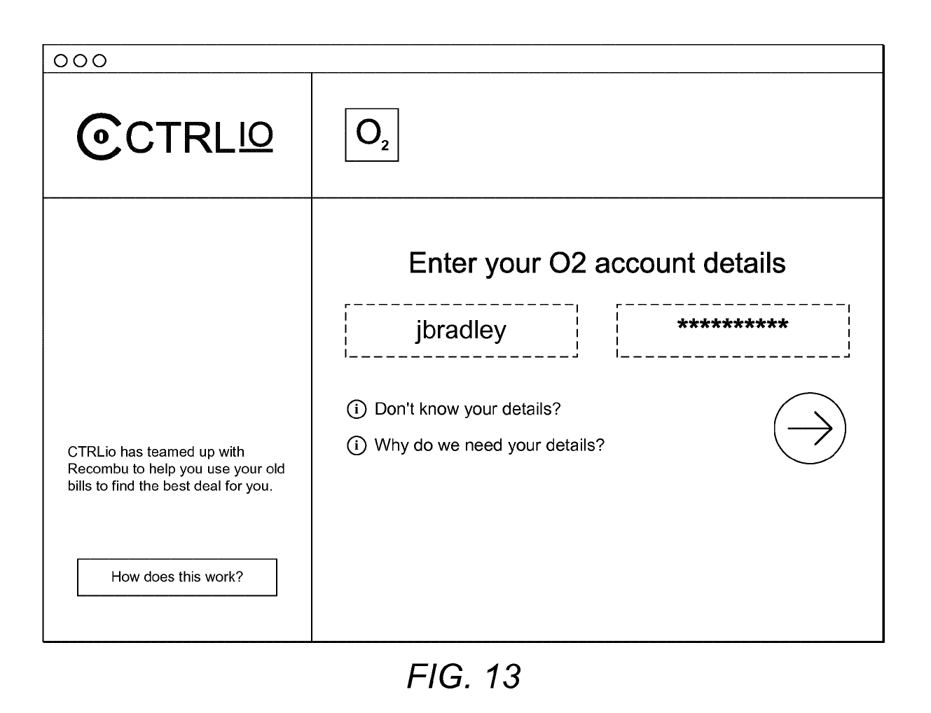

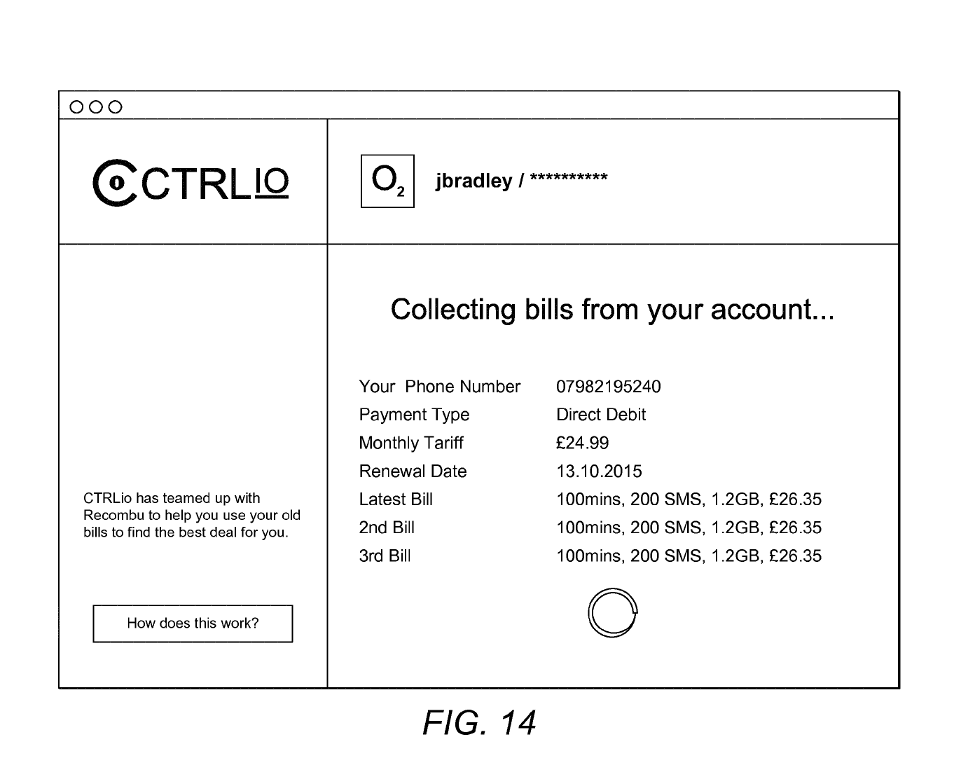

FIG. 13 shows a screen that is asking a user to authenticate themselves so that the usage data can be obtained from the user's mobile telephone service. This authentication process need only occur once and the future retrieval of usage data from the mobile telephone service by the personal data system 101 preferably does not require authentication by the user.

FIG. 14 shows that only the relevant data for obtaining offers from mobile telephone service providers 104 is obtained.

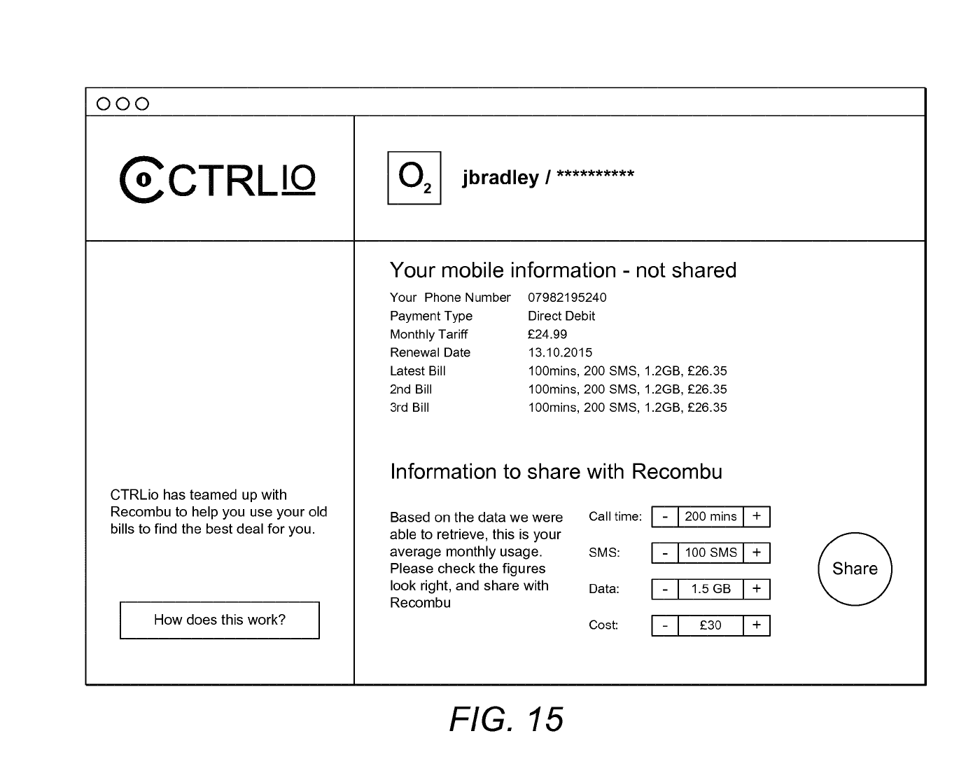

FIG. 15 shows that the user is clearly shown what personal data the personal data system 101 intends to use. The user can change any of this information and then authorise its use.

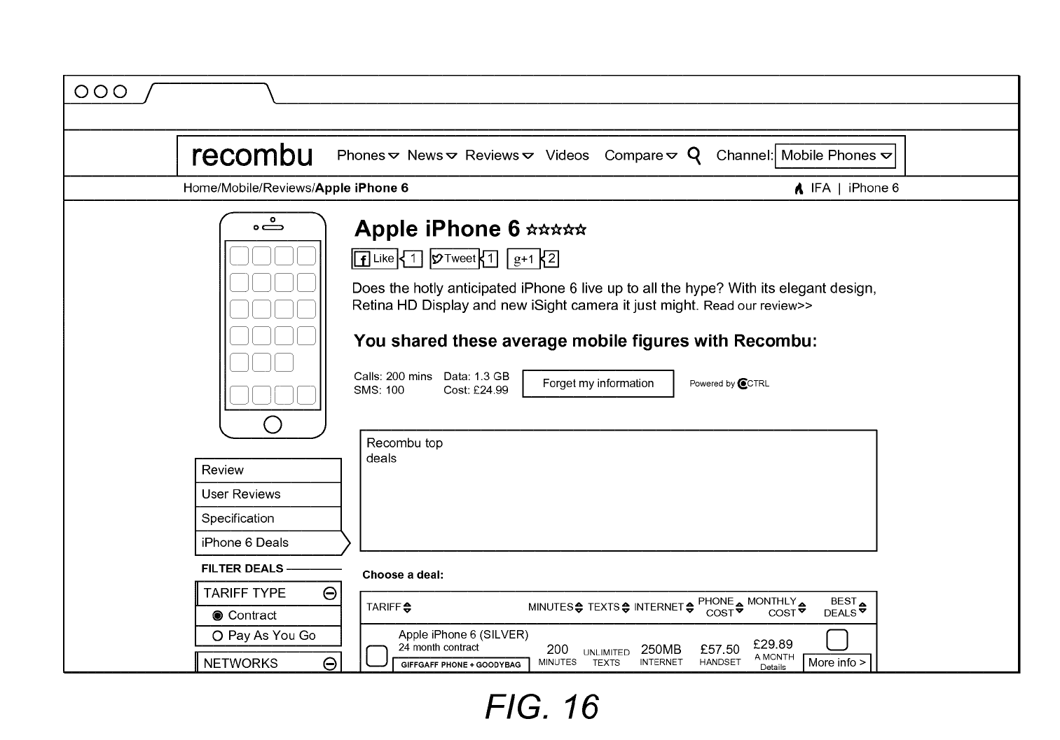

FIG. 16 shows the initial webpage re-launched so that it comprises offers that are personalised to the user. The user can also give an express command to the website telling it to not use and/or forget the shared personal data so that the website is launched again without any personalisation to the user.

Embodiments of the invention also include a number of modifications and variations to the embodiments as described above.

For example, the system as shown in FIG. 1 may comprise one or more personal data system 101s, one or more user systems 102, one or more offer providers 103 and one or more service providers 104.

The personal data system 101 is preferably capable of supporting any number of user systems 102, offer providers 103 and service providers 104. The number of each of these may be in the order of hundreds of thousands or even millions.

Although embodiments have been described with a single personal data system 101 supporting a plurality of user systems 102, a personal data system 101 may be designed to support only one user system 102. In this implementation, a personal data system 101 may be located with each user system 102 and they may be sold as a combined unit.

Throughout the above-described embodiments, user preferences are referred to. These are to be understood as being any intention or description of a product, service, preference, or anything that is beneficial to a user. In particular, the preferences may be active preferences that are actions that a user intends to perform.

Throughout the above-described embodiments offers from offer providers 103 are referred to. These include providers of any form of service, product or deal. A service provided by an offer provider 103 according to an embodiment includes, for example, the service of informing a user of an appropriate time to arrange a meeting given determined expected movements and activities of other people. The required information can be determined from, for example, records of peoples locations recorded by their mobile telephones.

Preferably, a user consents to some or all of their personal data being used personalise their entire browsing experience on the Internet. This is also used by the personal data system 101 to automatically obtain advice and suggestions for the user, as well as offers, and include these in the personal information document 301. The user would have the option to turn on and off the automatic personalisation by the personal data system 101. When the personalisation is turned on, as well as advice, suggestions and offers, this may result in the user also been displayed with user targeted advertisements and other user personalised information.

Preferably, in the second embodiment, a user can select an option for their personal data to be saved for reuse. If the user browses to another webpage, the personalisation data can then be used again to personalise offers to the user.

The personal data system 101 preferably generates reminders and/or notifications presents these to a user. For example, a user may be reminded that their car insurance requires renewing, as determined by an expected user preference, and be automatically provided with offers from car insurance providers. Preferably, this is implemented by using states and triggers. A trigger may be set within 1 month of the renewal date that changes the expected user preference of renewing car insurance from inactive to active. The detected acceptance of a car insurance offer can then cause the state to change back to inactive so that the user is no longer presented with offers for car insurance.

Preferably, the offer providers 103 are required to provide offers according to an auctioning, or reverse auctioning, process. This can result in a user being provided with more competitive offers.

Preferably the personal data system 101 is able to store multiple user profiles and/or personal information document 301s for a single user. For example, a user may have a personal profile and a work profile.

In all of the above-described embodiments, the personal data system 101 preferably obtains offers for presenting to a user according to the secure techniques of the fourth embodiment and thereby avoids providing personal data to third party systems. However, embodiments also include processes for generating offers by providing personal data of the user to third party systems. Only personal data that has been approved for sharing by the user is ever provided so the user remains in control of the shared data.

The flowcharts and description thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

1-29. (canceled)

30. A computer-implemented method for obtaining one or more offers for a user, the method comprising a secure computing environment within a computing system:
receiving personal data of a user that has been authorised for use by the user and is associated with a confirmed user preference of the user;
receiving offer data from one or more third party offer providers;
generating one or more offer results in dependence on the offer data and personal data; and
outputting the one or more offer results.

31. The method according to claim 30, further comprising providing one or more third parties with data in dependence on the personal data of the user such that the one or more third parties are able to determine offers in dependence on the user's personal data.

32. The method according to claim 30, wherein the personal data of the user is a user preference profile of the user.

33. The method according to claim 30, wherein the offer results are dependent on user configured preferences determining when, how and under what conditions the offer results are presented to a user.

34. The method according to claim 30, wherein the received offer data comprises one or more externals that are each generated by a third party offer provider; and
each of the one or more offer results is one of the externals comprised by the received offer data.

35. The method according to claim 30, wherein the secure computing environment obtains the personal data from a personal data source of the user.

36. The method according to claim 35, wherein the communication between the secure computing environment and the personal data source is restricted such that the secure computing environment is only able to read data from the personal data source.

37. The method according to claim 35, wherein the personal data source is a user profile, wherein the user profile is generated using a method comprising:
obtaining, over a network, personal usage data of a user from one or more third party personal data sources, wherein each personal data source comprises personal usage data associated with actions and/or behaviours of a user;
generating one or more inferred user preferences in dependence on an analysis of the obtained personal usage data;
receiving confirmation from the user that at least one of the inferred user preferences is an actual user preference; and
storing the user confirmed inferred user preferences in a user profile.

38. The method according to claim 35, wherein the personal data source is a user preference profile, the method further comprising:
using the user preference profile to obtain personalised offers for a user and/or personalised advice; and
storing the generated user preference profile and obtained personalised offers and/or personalised advice in a personal information document.

39. The method according to claim 30, wherein the secure computing environment is a sandbox.

40. The method according to claim 34, wherein the one or more externals are URLs.

41. The method according to claim 30, wherein the received offer data comprises algorithm and/or configuration data generated by the third party offer providers.

42. The method according to claim 30, further comprising receiving further offer data from one or more third party offer providers; and
updating the offer data used within the secure computing environment such that one or more offer results are generated in dependence on the further offer data.

43. The method according to claim 30, further comprising generating proposals for presenting to a user in dependence on the one or more offer results.

44. A computing system configured to obtain one or more offers for a user, the system comprising:
a secure computing environment configured to receive offers from third party offer providers;
a provider repository within said secure computing environment, configured to receive at least one of data and algorithms from third party providers; and
a matching engine, operating within said secure computing environment, configured to apply the at least one of data and algorithms from third party providers with preference data of the user to identify one or matching offers.

45-58. (canceled)

59. The method according to claim 30, wherein the only data output from the secure computing environment is received by the secure computing environment.

60. The system according to claim 44, wherein the secure computing environment is a sandbox.

61. The system according to claim 44, wherein the algorithm configuration repository is configured to hold any of configuration data, third party algorithms, and externals.

62. The system according to claim 44, wherein one or more offers are presented in HTML format.

63. A non-transitory computer readable medium having stored therein instructions that when executed cause a computer to perform a method of obtaining on or more offers for a user, the method comprising:
receiving personal data of a user that has been authorised for use by the user and is associated with a confirmed user presence of user;
receiving offer data from one or more third party offer providers;
generating one or more offer results in dependence on the offer data and personal data; and
outputting the one or more offer results.
